(19) United States
(12) Patent Application Publication
(10) Pub. No.: US 2005/0230379 A1
(43) Pub. Date: Oct. 20, 2005

(54) System and method for heating a workpiece during a welding operation

(76) Inventors: Vianney Martawibawa, Central Mid Levels (HK); Jim Keegan, Troy, OH (US); Fuhu Chen, Beavercreek, OH (US)

Correspondence Address: Patrick S. Yoder;FLETCHER YODER, P.O. Box 692289, Houston, TX, 77269-2289, US

(21) Appl. No.: 10/827,703

(22) Filed: Apr. 20, 2004

(51) Int. Cl. B23K 9/16

(52) U.S. Cl. 219/617

(57) ABSTRACT

A technique for heating a workpiece during welding is provided. The technique may comprise a heating system and a welding system. The heating system may be an induction heating system. The heating system is provided to heat the workpiece to a desired temperature and maintain the workpiece at the desired temperature as a weld joint is formed. Because the workpiece temperature is elevated, the difference in temperature between the filler material in the weld joint and the workpiece is reduced. The reduction in the temperature difference between the filler material in the weld joint and the workpiece produces a lower rate of heat transfer from the filler material in the weld joint to the workpiece. The lower rate of heat transfer, in turn, produces a slower rate of temperature decrease in the weld joint.

### BACKGROUND OF THE INVENTION

The present technique relates generally to manufacturing systems and methods. More specifically, a technique is provided for heating a weld joint during a welding operation to control the cool down rate of the weld joint.

Welding is a method that is used in manufacturing to join metal workpieces. A flame or electric arc may be used to provide heat to produce a molten state in the workpieces. Once molten, the material of each workpiece is able to flow together. When the flame or electric arc is removed, the molten material will cool and solidify forming a weld joint joining the two workpieces.

A filler material, such as an electrode, may be used to add mass to the weld joint. The mechanical properties of the filler material may be adversely affected by the rate at which the weld joint cools from a molten state when the flame or arc is removed. Typically, a greater cool down rate of the weld joint is more detrimental to the material characteristics of the weld joint than is a lower cool down rate. For example, a weld joint that cools at a greater cool down rate will generally be more brittle than a weld joint experiencing a lower cool down rate. In addition, the more brittle a weld joint is, the more at risk the weld joint is for brittle fracture. Brittle fracture is a sudden catastrophic failure of a metal that may occur when the workpiece is below a transition temperature.

Various factors affect the rate at which the weld joint cools down from a molten state to a solid state. For example, the weld joint of a larger work piece typically has a greater rate of temperature decrease than the weld joint of a smaller workpiece because the mass of the metal in the larger workpiece enables a greater amount of heat to be transferred from the weld joint by conduction. A technique that enables the cool down rate of a weld joint formed between two workpieces to be reduced may be desirable.

### SUMMARY OF THE INVENTION

A technique for heating a workpiece during welding is provided. The technique may comprise a heating system and a welding system. The heating system may be an induction heating system. The heating system is provided to heat the workpiece to a desired temperature and maintain the workpiece at the desired temperature as a weld joint is formed. Because the workpiece temperature is elevated, the difference in temperature between the filler material in the weld joint and the workpiece is reduced. The reduction in the temperature difference between the filler material in the weld joint and the workpiece produces a lower rate of heat transfer from the filler material in the weld joint to the workpiece. The lower rate of heat transfer, in turn, produces a slower rate of temperature decrease in the weld joint.

### BRIEF DESCRIPTION OF THE DRAWINGS

The foregoing and other advantages of the invention will become apparent upon reading the following detailed description and upon reference to the drawings in which:

FIG. 1 is a diagram illustrating an exemplary system having an induction heating system and a welding system, in accordance with an exemplary embodiment of the present technique;

FIG. 2 is a table of test result data for weld joints produced by inductively heating a workpiece during welding using a first electrode to provide filler material to the weld joint, in accordance with an exemplary embodiment of the present technique;

FIG. 3 is a table of test result data for weld joints produced by inductively heating a workpiece during welding using a second electrode to provide filler material to the weld joint, in accordance with an exemplary embodiment of the present technique; and

FIG. 4 is a table of test result data for weld joints produced by heating a workpiece using a flame during welding with the first electrode, in accordance with an exemplary embodiment of the present technique.

### DETAILED DESCRIPTION OF SPECIFIC EMBODIMENTS

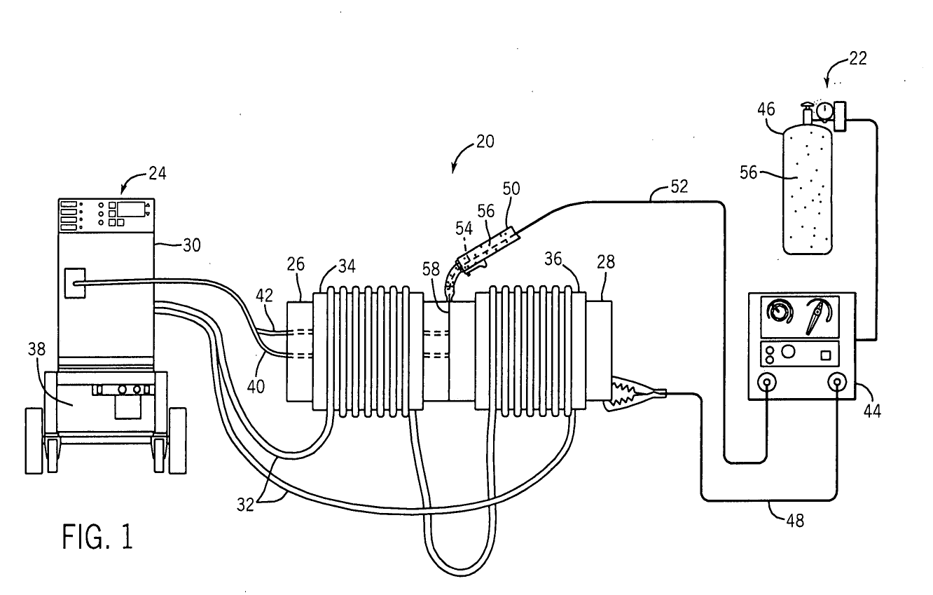

Referring generally to FIG. 1, a system 20 for manufacturing a workpiece, such as a pipeline, is illustrated. The illustrated system 20 comprises a welding system 22 and an induction heating system 24. The welding system 22 is operable to enable a user to weld a first pipe section 26 to a second pipe section 28. The induction heating system 24 is operable to provide heat to the first pipe section 26 and the second pipe section 28 before welding, during welding, and after welding. However, other types of heating systems may be used, such as a resistive heating system or a torch operable to produce a flame. The pipe sections 26, 28 are comprised of a ferrous metal, such as X60, X70, or X80 steel. However, the pipe sections may be comprised of other ferrous metals.

The illustrated induction heating system 24 comprises an induction heating power source 30 and an induction heating cable 32. The induction heating cable 32 is coiled around the first pipe section 26 and the second pipe section 28. The induction heating power source 30 produces an alternating current that causes the induction heating cable 32 to produce a varying magnetic field. The varying magnetic field produced by the induction heating cable 32 induces a flow of eddy currents in the first pipe section 26 and the second pipe section 28. The eddy currents, in turn, raise the temperature of the first pipe section 26 and the second pipe section 28. The induction heating cable 32 may comprise several induction heating cables connected together. In addition, the induction heating system 24 may comprise a second induction heating power source, each power source being used to heat one pipe section.

In the illustrated embodiment, a first insulated blanket 34 is disposed over the first pipe section 26 and a second insulated blanket is disposed over the second pipe section 28. The insulated blankets 34, 36 protect the induction heating cable 32 from heat damage caused by the elevated temperatures of the first pipe section 26 and the second pipe section 28. In addition, in this embodiment, the induction heating cable 32 is fluid cooled. However, an air-cooled induction heating device also may be used. A fluid cooling unit 38 is provided to provide a flow of cooling fluid to cool the induction heating cable 32.

The induction heating system 24 also comprises a first temperature feed back device 40 and a second temperature feed back device 42. The first temperature feed back device 40 provides a signal representative of temperature of the first pipe section 26 to the induction heating power source 30. Similarly, the second temperature feed back device 42 provides a signal representative of temperature of the second pipe section 28 through the induction heating power source 30. However, a single temperature feedback device may be used. The induction heating power source 30 may be programmed to establish a desired temperature in the first pipe section 26 and the second pipe section 28 based on the temperature feed back from the first and second temperature feed back devices 40, 42.

In the illustrated embodiment, the welding system 22 comprises a power source/wire feeder 44 that is operable to provide a flow of electrode wire to serve as filler material to the weld joint 54 and also provides power to produce an electric arc between the electrode wire and the workpiece. The welding system 22 may also comprise a gas cylinder 46 to provide a flow of gas to shield the molten weld puddle formed by the arc. The power source/wire feeder 44 is coupled to the second pipe section 28 by a ground cable 48. The welding system 22 also comprises a welding implement 50 that is coupled to the power source/wire feeder 44 by a welding cable 52. The welding cable 52 couples the electrode wire 54 and the shield gas 56 to the welding implement 50. When the electrode wire 54 contacts one of the pipe sections, a circuit is completed and electric current is conducted from the electrode wire 54 to the pipe sections via the welding cable 52, producing an arc.

The arc produced by the welding system 22 produces localized melting of the first pipe section 26 and the second pipe section 28. When the arc is removed, the circuit is opened and current no longer flows from the power source/wire feeder 44 to the pipe sections 26, 28. The molten material cools and solidifies, forming a weld joint 58. The induction heating system 24 maintains the first and second pipe sections 26, 28 at an elevated temperature during the welding process. The elevated temperature of the pipe sections 26, 28 reduces the temperature difference between the molten material/weld joint 58 and the first and second pipe sections 26, 28. This reduces the rate of heat transfer from the molten material/weld joint 58 to the pipe sections 26, 28, and reduces the cool down rate of the molten material/weld joint 58.

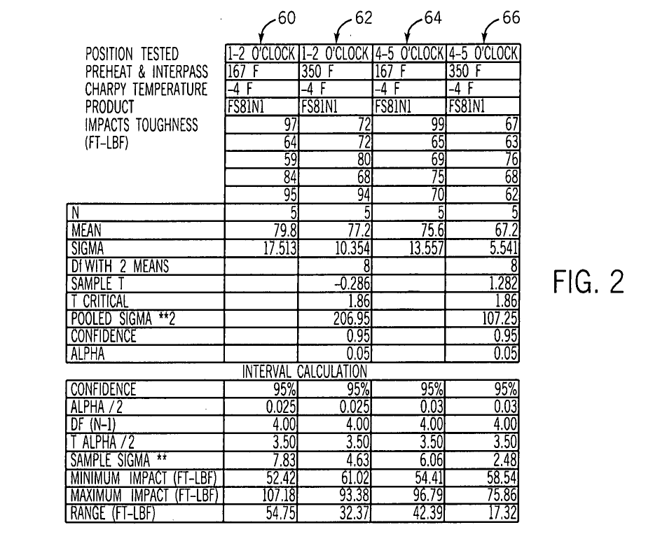

A series of tests was performed on a weld joint formed using the technique described above. Data obtained from the series of tests is provided in FIG. 2. The system was used to weld together two pipe sections comprised of X70 steel and having a corrosion resistant coating. The pipe sections had a diameter of forty-two inches. The corrosion resistant coating had a temperature limit of 350° F. An initial weld root was formed between the pipe sections using a PM70 stick electrode. Hobart Brothers Fabshield 81N1 electrode wire was then used as filler material to fill the weld joint. Fabshield 81N1 is a self-shielded electrode wire of the T8 type. The Fabshield 81N1 is classified as an E71T8-Ni1J electrode wire within the American Welding Society A5.29 specification. The filler material was added in a series of vertical welds performed from the top of the pipe sections downward. One group of pipe sections was maintained at a temperature of 167° F. during welding and a second group of pipe sections was maintained at a temperature of 350° F. during welding. The temperature of the pipe sections was maintained by an induction heating system during the welding process.

Afterward, a Charpy impact tester was used to obtain fracture toughness data for samples taken from the weld joints between the 1 and 2 o'clock positions and between the 4 and 5 o'clock positions of the pipe section. The samples were cooled to a temperature of −4° F. to perform the impact test. The first column of FIG. 2, represented by reference numeral 60, represents the data obtained from the location between the 1 and 2 o'clock positions of the pipe section weld joint with the pipe section heated to a temperature of 167° F. The second column of data, represented by reference numeral 62, represents the data obtained from the location between the 1 and 2 o'clock positions of a weld joint formed with the pipe sections heated to a temperature of 350° F. The third column of data, represented by reference numeral 64, represents the data obtained from the location between the 4 and 5 o'clock positions of the weld joint formed with the pipe sections heated to a temperature of 167° F. Finally, the fourth column of data, represented by reference numeral 66, represents the data obtained from the location between the 4 and 5 o'clock positions of the weld joint formed with the pipe sections heated to a temperature of 350° F.

The data obtained from the Charpy impact tests was analyzed using various statistical methods, the results of which are provided in FIG. 2. The fracture toughness data from the first two tests were pooled. The statistical methods indicated a confidence level of 95% in the fracture toughness data obtained from the first two tests. Similarly, the fracture toughness data from the second two tests were pooled. The statistical methods also indicated a confidence level of 95% in the fracture toughness data obtained from the second two tests.

The data was also used to extrapolate an expected minimum impact toughness value, an expected maximum impact toughness value, and the range of toughness values, i.e., the difference of the expected maximum and minimum values. In each of the tests, the minimum impact toughness values were higher in the weld joints in the pipe sections that were heated to the higher temperature and therefore the weld joints cooled down at a lower rate of temperature decrease. For example, the minimum expected impact toughness value as a result of the sample taken from between the 1 and 2 o'clock position of the pipe sections maintained at a temperature of 167° F. during welding is 52.42 ft-lbf, as opposed to 61.02 ft-lbf for the pipe sections maintained at 350° F. Similar impact toughness results were obtained in the sample taken between the 3 and 4 o'clock position, 54.41 ft-lbf for the pipe sections maintained at 167° F. during welding and 58.54 ft-lbf for the pipe sections maintained at 350° F. during welding. A pipe section is only as strong as its weakest link. Therefore, the pipe section heated to 350° F. is expected to be stronger than the pipe section heated to 167° F. The ranges of the impact toughness values were narrower in the pipe sections maintained at 350° F. during welding (32.37 ft-lbf and 17.32 ft-lbf) than in the pipe sections maintained at 167° F. during welding (54.75 ft-lbf and 42.39 ft-lbf), thus producing more consistent mechanical properties throughout the weld joint.

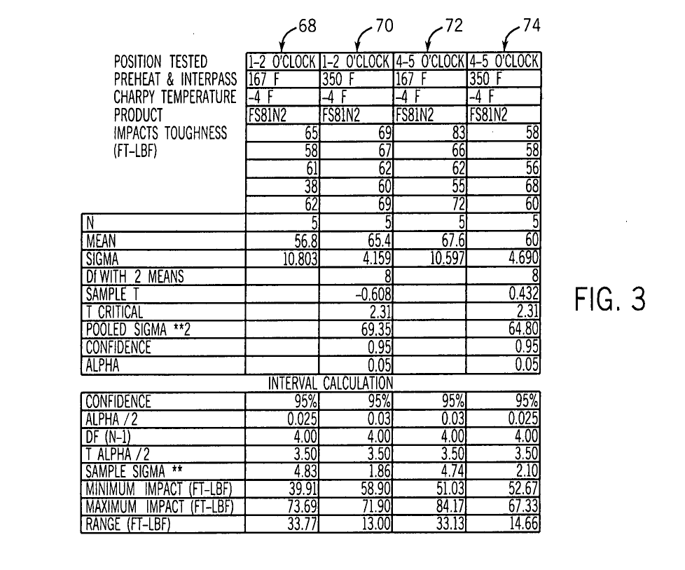

A second series of tests was performed using the technique described above, but with an electrode wire having greater nickel content. Data obtained from the series of tests is provided in FIG. 3. As with the previous test, the system was used to weld two forty-two inch diameter pipe sections comprised of X70 steel and having a corrosion resistant coating. An initial weld root was formed between the pipe sections using a PM70 stick electrode. Hobart Brothers Fabshield 81N2 electrode wire was then used as filler material to fill the weld joint. Fabshield 81N2 is a self-shielded electrode wire of the T8 type. One group of pipe sections was maintained at a temperature of 167° F. during welding and another group of pipe sections was maintained at a temperature of 347° F. The temperature of the pipe sections was maintained by an induction heating system during the welding process.

Once again, a Charpy impact tester was used to obtain impact toughness data from samples taken from the weld joint formed with the Fabshield 81N2 electrode wire at the 1-2 o'clock position and the 4-5 o'clock position of the weld joints. These samples were then cooled to a temperature of −4° F. to perform the test. The first column of FIG. 3, represented by reference numeral 68, represents the data obtained from the 1-2 o'clock position of a weld joint with the pipe sections maintained at 167° F. during welding. The second column of data, represented by reference numeral 70, represents the data obtained between the 1 and 2 o'clock positions with the pipe sections maintained at a temperature of 350° F. during welding. The third column of data, represented by reference numeral 72, represents the data obtained between the 4 and 5 o'clock positions of the weld joint formed with the pipe sections heated to a temperature of 167° F. Finally, the fourth column of data, represented by reference numeral 74, represents the data obtained from between the 4 and 5 o'clock position of the weld joint formed with the pipe sections heated to a temperature of 350° F.

The data obtained from the Charpy impact tests was analyzed using various statistical methods to establish confidence in the results, the results of which are provided in FIG. 3. This data was also used to extrapolate an expected minimum impact toughness value, an expected maximum impact toughness value, and the range of toughness values, i.e., the difference of the expected maximum and minimum values. In each of the tests, the minimum impact toughness values were higher in the weld joints in the pipe sections that were heated to the higher temperature and therefore the weld joints cooled down at a lower rate of temperature decrease. For example, the minimum expected impact toughness value as a result of the sample taken between the 1 and 2 o'clock position of the pipe sections maintained at a temperature of 167° F. during welding is 39.91 ft-lbf, as opposed to 58.90 ft-lbf for the pipe sections maintained at 350° F. Similar impact toughness results were obtained in the sample taken between the 3 and 4 o'clock position, 51.03 ft-lbf for the pipe sections maintained at 167° F. during welding and 52.67 ft-lbf for the pipe sections maintained at 350° F. during welding. The ranges of the impact toughness values were narrower in the pipe sections maintained at 350° F. during welding (13.00 ft-lbf and 14.66 ft-lbf) than in the pipe sections maintained at 167° F. during welding (33.77 ft-lbf and 33.13 ft-lbf), thus producing more consistent mechanical properties throughout the weld joint.

A third series of tests was performed using the technique described above, but using a flame torch rather than an induction heating system. Data obtained from the series of tests is provided in FIG. 3. In this test, the system was used to weld together two twenty-four inch diameter pipe sections comprised of X70 steel. Hobart Brothers Fabshield 81N1 electrode wire was then used as the filler material to fill the weld joint. The pipe sections were maintained at a temperature of 250° F. during welding.

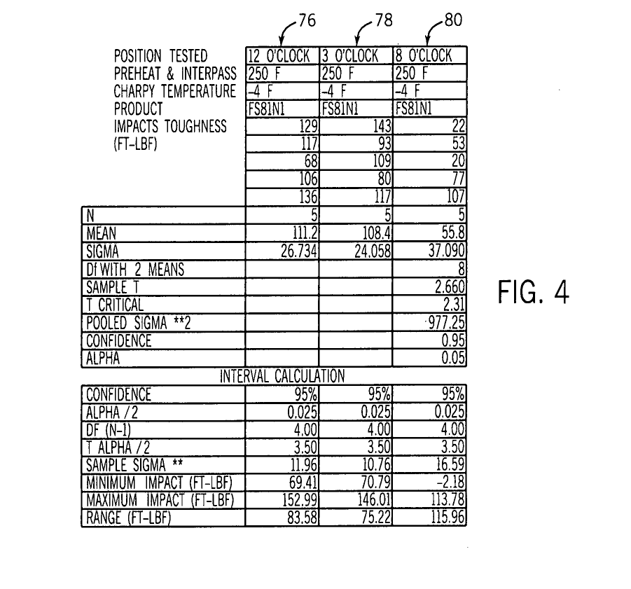

Impact toughness data was obtained from samples taken from the weld joint at the 12 o'clock position, the 3 o'clock position, and the 6 o'clock position of the pipe sections. The samples were then cooled to a temperature of −4° F. to perform the test. The first column of FIG. 4, represented by reference numeral 76, represents the data obtained from the 12 o'clock position of the pipe section. The second column of data, represented by reference numeral 78, represents the data obtained from the 3 o'clock position of the pipe section. The third column of data, represented by reference numeral 80, represents the data obtained from the 6 o'clock position of the pipe section.

As with the other tests, the data obtained from the impact tests was analyzed using various statistical methods to establish confidence in the test results, the results of which are provided in FIG. 4. The data was also used to extrapolate an expected minimum impact toughness value, an expected maximum impact toughness value, and the range of expected toughness values at each of the locations of the weld joint tested. The minimum expected impact toughness values varied greatly between the locations. For example, the minimum expected impact toughness value at the 3 o'clock position was 70.79 ft-lbf, while the minimum expected impact toughness at the 6 o'clock position was −2.18 ft-lbf As a result, the range of expected impact toughness values also varies greatly between the different locations of the pipe section. Thus, the heating performed using the induction heating system produced more consistent mechanical properties in the weld joint than did the heating provided by the flame.

The techniques described above enable a weld joint to be produced that has better and more consistent mechanical properties. The weld joints formed using the technique described above produce a weld joint that has a higher and more uniform impact toughness.

1. A method of manufacturing, comprising:
welding a first workpiece to a second workpiece to form a weld joint; and
applying heat to the first workpiece and the second workpiece adjacent to the weld joint to reduce temperature differences between the weld joint and the first and second workpieces as the weld joint is formed.

2. The method as recited in claim 1, wherein applying heat to the first workpiece and the second workpiece comprises maintaining the portions of the first workpiece and the second workpiece adjacent to the weld joint at a desired temperature during cooling of the weld joint from a molten state to a solid state.

3. The method as recited in claim 2, wherein the first workpiece is a first pipe section and the second workpiece is a second pipe section.

4. The method as recited in claim 3, wherein the desired temperature is at least 165° F. and does not exceed a temperature limit for the first pipe section and the second pipe section.

5. The method as recited in claim 4, wherein the temperature limit is a temperature limit for a corrosion coating disposed on the first pipe section and the second pipe section.

6. The method as recited in claim 5, wherein the temperature limit for the corrosion coating is approximately 350° F.

7. The method as recited in claim 5, wherein the desired temperature is at least 300° F.

8. The method as recited in claim 4, wherein the first pipe section and the second pipe section comprise X70 steel.

9. The method as recited in claim 1, wherein applying heat to the first work piece and the second work piece comprises inductively heating the first work piece and the second work piece.

10. The method as recited in claim 1, wherein applying heat to the first pipe section and the second pipe section comprises resistively heating the first work piece and the second work piece.

11. A method of welding, comprising:
forming a weld joint between a first workpiece and a second workpiece by adding filler material to the weld joint as heat is applied to the first workpiece and the second workpiece to maintain a desired temperature in the first and second workpieces adjacent to the weld joint.

12. The method as recited in claim 11, wherein filler material is added to the weld joint in a series of passes and heat is applied to the first workpiece and the second workpiece to maintain a desired temperature in the weld joint before each pass in the series of passes.

13. The method as recited in claim 12, wherein the desired temperature is at least 165° F. and does not exceed a temperature limit for a corrosion coating disposed on the first workpiece and the second workpiece.

14. The method as recited in claim 13, wherein the desired temperature is at least 300° F.

15. The method as recited in claim 13, wherein the desired temperature does not exceed 400° F.

16. The method as recited in claim 11, wherein the first workpiece and the second workpieces are pipe sections having a diameter greater than thirty inches in diameter.

17. The method as recited in claim 16, wherein the first pipe section and the second pipe section comprise X70 steel.

18. The method as recited in claim 11, comprising heating the first and second workpieces with an induction heating system.

19. A workpiece, comprising a weld joint formed in accordance with the process of claim 11.

20. A method of manufacturing, comprising:
operating a heating system to apply heat to a first workpiece and a second workpiece to maintain a desired temperature in the first and second workpieces adjacent to a weld joint as filler material in the weld joint cools from a molten state to a solid state during welding.

21. The method as recited in claim 20, wherein filler material is added to the weld joint in a series of passes and the heating system is operated to maintain a desired temperature in the weld joint before each pass in the series of passes.

22. The method as recited in claim 20, wherein the desired temperature is at least 165° F. and does not exceed a temperature limit for a corrosion coating disposed on the first workpiece and the second workpiece.

23. The method as recited in claim 22, wherein the first workpiece and the second workpiece comprise X70 steel.

24. The method as recited in claim 23, wherein the first workpiece is a pipe section having a diameter greater than thirty inches in diameter.

25. The method as recited in claim 22, wherein the desired temperature is at least 300° F.

26. The method as recited in claim 25, wherein the desired temperature does not exceed 400° F.

27. The method as recited in claim 20, wherein heat is applied to the first workpiece and the second workpiece using an induction heating system.

28. The method as recited in claim 20, wherein heat is applied to the first workpiece and the second workpiece using a resistive heating system.

29. The method as recited in claim 20, comprising welding the first workpiece to the second workpiece to form a weld joint.

30. A workpiece, comprising a weld joint formed in accordance with the process of claim 29.

31. A method of reducing a cooldown rate of a weld joint during formation of the weld joint, comprising:
disposing an induction heating device adjacent to a region of a workpiece in which the weld joint is to be formed;
coupling the induction heating device to an induction heating power source; and
operating the induction heating power source to apply power to the induction heating device to heat the region of the workpiece to reduce the temperature differential between molten filler material in the weld joint and the workpiece.

32. The method as recited in claim 31, wherein operating the induction heating system to reduce the temperature differential between molten filler material in the weld joint and the workpiece reduces the rate of heat transfer from the molten filler material in the weld joint to the workpiece.

33. The method as recited in claim 32, wherein the weld joint is formed between a first workpiece and a second workpiece.

34. The method as recited in claim 33, wherein disposing an induction heating device comprises disposing the induction heating device around the first workpiece and the second workpiece on opposite sides of the weld joint.

35. The method as recited in claim 34, wherein operating the induction heating power source comprises applying power to heat the first and second workpieces to reduce the temperature differential between molten filler material in the weld joint and the first and second workpieces.
